(19) United States
(12) Patent Application Publication
(10) Pub. No.: US 2026/0111649 A1
(43) Pub. Date: Apr. 23, 2026

(54) METHODS AND DEVICES FOR LANGUAGE IMAGE NATURAL MODELING ARCHITECTURE

(71) Applicant: BING LIN, Beijing (CN)

(72) Inventor: BING LIN, Beijing (CN)

(21) Appl. No.: 18/922,460

(22) Filed: Oct. 22, 2024

(51) Int. Cl. G06F 40/129

(52) U.S. Cl. CPC G06F 40/129

(57) ABSTRACT

Methods, devices and non-transitory storage medium for language image natural modeling architecture, with operations performed by one or more processors; relative data processing comprises: acquiring; recognizing; displaying/demonstrating; establishing a corresponding mapping relationship between language textual symbols and various forms, shapes, postures, motion trajectories extracted from visual graphic images, video stream images, key node position sensing information; wherein this mapping relationship comprises: symbolizing the shapes and action forms into language textual symbols; and vice versa shaping and action forming the language symbols; generating, by comprehensively utilizing various types of converting by depicting parts based on basic shape of parts, or by depicting shape and position of large limbs or extremities, or by depicting motion trajectory, a string of text symbols or a sequence of action shapes, to form an expression with specific meanings, to be used for recording, storing, reproducing, human-machine interactive communication.

### TECHNICAL FIELD

The present disclosure pertains to the fields of artificial intelligence, computer vision, machine learning, human-machine interaction, assistive technology, and robotics.

### BACKGROUND OF THE INVENTION

In the 2020s, large language model (LLM) technology advanced rapidly, with ChatGPT leading a wave of explosive AI transformation and demonstrating significant technical potential in the field of artificial intelligence.

Multimodal AIGC (Artificial Intelligence Generated Content) technology aims to integrate and process various forms of information such as language text, graphics, images, audio, and video. Large language models play a central role in this integration, serving as the core for processing text and interfacing with modules that handle visual imagery, video, and audio information, thus building a complex multimodal information processing system.

Through big data and large-scale deep learning, these systems acquire extensive parameters, enabling them to handle a wide range of complex scenarios with intelligence. The entire learning and processing process requires high-performance hardware, with large models, big data, and massive scales necessitating the handling, scanning, and computation of vast amounts of information at a high-intensity computing power costs.

Large language models based on Transformer architectures operate by extensively scanning existing human knowledge corpora to build a database of word association probabilities. Based on computed probability values, they predict and generate sequences of words. The advantage is that after training, it can cope with intellectual challenges in various aspects; however, a potential issue is that they may not fully understand the underlying logic of content, leading to occasional low-level errors and intellectual vulnerabilities.

Spatial intelligence is the ability to understand and manipulate visual and spatial information. It involves skills such as spatial reasoning, visualization, and orientation. People with high spatial intelligence are typically good at understanding visual representations and spatial relationships between objects, and be able to visualize objects in their mind's eye. This type of intelligence is important in fields such as architecture, engineering, art, and design.

Visual information contains a large volume of data, and various kinds of information are mixed, but only a portion of it is relevant or of interest. The challenge lies in, how to extract and obtain the information we care about from visual graphics, images, and video imagery? How to represent it? To what level of abstraction?

Intelligence compressing is to reduce the size of complexity of intelligence information while trying to retain its essential characteristics and value.

### SUMMARY OF THE INVENTION

The object of the present disclosure is to construct a concise, effective, and lightweight language image natural modeling architecture (LINMA).

The is of the present disclosure is to establish a direct correspondence mapping relationship between visual images and textual elements.

Before proposing a specific solution, let's first examine the relationship between sign language, semaphore, and written language.
Sign Language: Utilizes the configuration of finger shapes to represent language text letters and build words.
Semaphore: Involves moving both arms, placing them in various positions and angles around the body, using combinations of arm postures and angles to express text letters. On a clock face, there are hour and minute hands, and the different positions and angles of these two hands indicate different times. In semaphore, the arms function like the two hands of a clock, utilizing position and angle to represent different language letters.

Principle of the present disclosure:
Make full, comprehensive and integrated use of the morphology, shape, and positional relationship of the main and terminal limbs, including arms, palms, fingers, legs, feet, mouth, tongue, etc.
Analyze and summarize the placement of the arms, simplify and abstract them into symbols with similar shapes to depict the postures of the arms.
Analyze and summarize the placement forms of the hands, including the direction of the palm of the hand, the vertical relationship between the palm and the wrist, simplify and abstract them into symbols with similar forms to depict the postures of the hand shapes.
Analyze, summarize, and classify the movement trajectories of body parts during the process of shape changing, and describe them in symbolic format based on the shape characteristics of the trajectories.

A specific posture action sequence has a specific function and completes a specific function. It can be fixed, programmed, and streamlined, and can be continuously optimized until it is finalized.

The target object of the expression of the meaning of a specific modeling action posture can be the function of the modeling posture itself, or can refer to the interactive objects involved in the modeling action.

As for visual restoration, based on static graphic images, the modeling postures before and after are inferred to fill in and form a continuous and complete modeling action sequence.

Various limb organs are the basic components of the bodies of human and animal species, and they are the basic tools for animal species to interact and communicate with the natural world. External limbs and internal organs have different characteristics: under normal circumstances, internal organs are invisible and do not have the characteristics of visual presentation, while external limbs are organs that can be visually presented. Because they can be visually presented, they have the function of generating visual information. The main and basic functions of animal limbs and organs are to support and move the body, to hunt for food, and so on. Visual information presentation is an additional function, which can play a role in demonstration, communication and exchange. Whether a species can fully develop and utilize these additional information functions is an important aspect to judge the accumulation and evolution of species intelligence. By comprehensively understanding and mastering the essence of these visual information carriers, human beings have evolved into higher form of intelligence, which enables them to surpass other species.

### BRIEF DESCRIPTION OF DRAWINGS

FIG. 1 depicts an example system for language image natural modeling architecture, according to implementations described herein;

FIG. 2 depicts examples of mapping conversion between textual symbol and shape, limb posture, motion trajectory.

### DETAILED DESCRIPTION OF THE INVENTION

### Body, Parts, Limbs

The arms and ten fingers are important limb organs of humans and similar species, such as monkeys, apes and other quadrumana. The relationship between the two arms is complicated and varied, and the placement and shape are also variable. They can accomplish a wide variety of functional tasks, and have evolved to the extent of being used at will.

It is necessary to analyze and describe various placements and shapes in detail.

When humans explore and understand things in the world, they need to establish an interactive relationship with the things, so that they can truly understand and master such things. Only by establishing a relationship with the body parts that humans can control, and this relationship is able to be expressed, reproduced, and understood, can the things be truly mastered.

Parts such as the arms and ten fingers are the body limb organs of humans themselves, which can be freely controlled and are the most familiar and controllable resource tools.

The limb shapes, postures, gestures, and movement patterns of humans and animals are visually perceivable and can be transformed into expressions by copying and depicting. Symbolic expression is achieved, and symbols and actions can be mapped and transformed into each other.

Symbolic text is obtained by copying the movement posture, and the movement posture can be restored from the symbolic text.

In order to complete specific target tasks, humans or animal species need to construct a series of subtle movement patterns and shapes, and perform shape switch transitions to achieve a specific task. Over time, a binding relationship is formed between specific tasks and specific movement shape transition sequences. The movement shape sequences gradually become fixed, programmed, and process-oriented.

Different individuals will get different results when observing and summarizing the movement postures from different angles. In the process of evolution, the schemes that are the simplest, most abstract, and most expressive will gain more recognition. Compatibility should be maintained as much as possible for existing symbolic schemes.

Analyze and examine several common life labor scenes: holding a stone, holding a child, holding a stick, and standing. From these basic scenes, look at the details of the body postures.

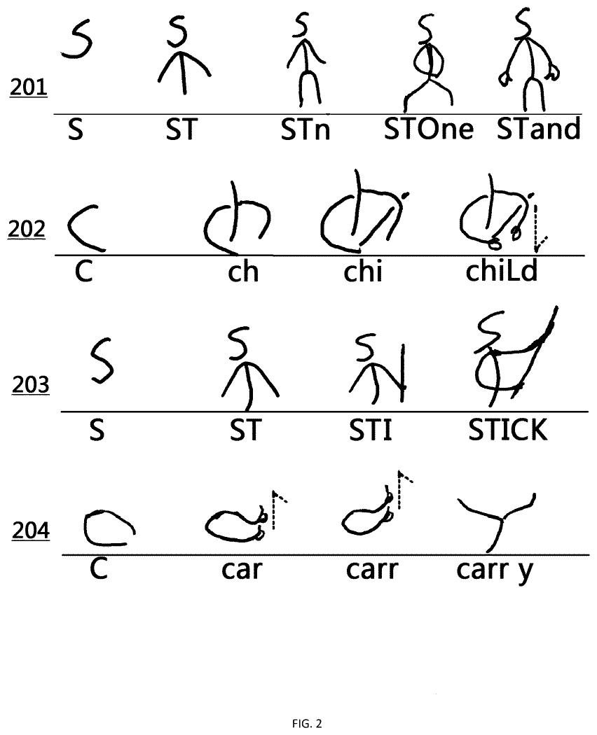

FIG. 2 depicts examples of mapping conversion between textual symbol and shape, limb posture, motion trajectory.

Firstly, let's look at the basic movements of human arms. When the human body is standing, the arms naturally hang down and are idle. When it is necessary to work, the arms are generally placed in front of the abdomen to interact with some objects.

The state of the arms naturally hanging down and slightly stretched can be depicted by T, which is similar to the shape of merging “Λ” (two arms) and “I” (trunk) together, with “I” covered by “Λ”, (or similar to “/|\”), as shown in 201, 203.

The arms are naturally bent in front of the body, and the shape of the arms is a semi-enclosed circular posture, which is depicted by C, also named as C shape, as shown in 204.

Standing, holding a stone, lifting it up, and carrying it away, if you look at this series of actions carefully, you will inevitably see the basic modeling postures such as T shape and C shape, as shown in 201, 204.

“Holding a stone” motion posture decomposition involves the following set of gesture motion sequences, as shown in 201:
Firstly, the main body of the action should stand in front of the stone.

To depict a standing posture:
s: Depicts the head;
T: Depicts both arms located on both sides of the thighs, similar to the shape of merging “Λ” (two arms) and “I” (trunk) together, with “I” covered by “Λ”, (or similar to “/|\”);
Then, both arms start to change the action:
O: Depicts both arms enclosing into a circular shape (to hold the stone);
Then describe the actions of the legs:
n: Depicts the legs;
e: Describes the legs spreading forward and sideways;
Among these symbols, “sTn” depicts the head, the trunk with both arms, and the legs respectively. Simply placing “T” below “s”, and “n” below “T”, a standing posture of humans or other animals is depicted;
In this way, the action modeling sequence of “holding a stone” is obtained: “sTone”. The action posture can also be restored from this symbol sequence.

Motion decomposition of “carrying items”, as shown in 204:
c: Depicts the bending of both arms to form a semi-circular shape;
a: Depicts the extension of the thumbs to stabilize the object being carried;
r: Describes the upward movement and trajectory of both arms;
r: Describes the further upward movement and trajectory of both arms;
y: Depicts both arms being raised above the head;
In this way, the carrying motion sequence is obtained: “carry”. The motion posture can also be restored from this symbol sequence.

For another example, when it comes to the concept of child, humans originally did not know how to express the concept of a child. If they just point to the child, squeaking and screaming, it is not easy to identify and understand. However, the interactive relationship that adults can have with a child is reflected in the ten fingers and both arms, which must be the action of holding a child. The actions that all mankind do to a child are the same, and they are born the same. The standard posture for holding a child with both arms is that one hand poses around the back, the other hand supports the hips, one hand is higher, and the other hand is lower, so that the child can remain in a sitting position.

How to depict the action of “holding a child”?

The basic shape is, as shown in 202:
The lower arm forms the C shape;
The higher arm forms the h shape, with elbow lifted;
ch is combined into the posture of holding a child with both arms;
Then, continue to add related action elements:
i: Depicts the small body of the child being held, (which can be represented by the little finger);
L: Describes the arms shaking and sliding downward;
d: Depicts the shape of the hand, with the palm lower than the wrist and the back of the hand facing forward;
Combined together, it is “chiLd”. Among them, c, h, L and d these four symbols are the basic elements of limb shape and movement postures, being combined to form a relatively complex action sequence. And “i” represents the operated thing or object. After the action sequence is fixed and stylized, the action sequence of holding a child can be used to refer to the child. The action of holding a child has an extremely high repetition rate and recognition rate. Using this action sequence to represent a child has become a kind of thinking model.

The above-mentioned action of holding a child can be further expanded. By shaking the arms up and down, such a sequence is obtained: “chiLdren”, in which “L” describes the arms sinking downward, and “r” describes the arms lifting upward. Thus, holding a child and shaking up-down is completed, and interaction with the child is achieved through this action.

Holding a stick is the most primitive and basic posture of human beings. Through mastering the use and swinging of sticks, human wisdom has accumulated, evolved, and upgraded.

The series of actions involved in “holding a stick” comprise, as shown in 203:
Maintaining a standing posture:
ST: The upper body is depicted in a posture with T placed below S.
S: Depicts the head;
T: Depicts the trunk with both arms located on both sides of the thighs, similar to the shape of merging “Λ” (two arms) and “I” (trunk) together, with “I” covered by “Λ”, (or similar to “/|\”);
Indicating the presence of an object (i.e. stick) in the hand:
i or I: Depicts an object being held in hand, (which can be represented by a wildcard or a small finger to signify being held);
Changing and forming a specific pose with both hands:
CK: Depicts the positions and shapes of the arms. One arm is bent and positioned in front of the abdomen, forming a “C” shape with the single arm. The other arm extends forward and upward, forming the upper single-arm shape of a “K”.
CK: Alternatively, both arms can first be arranged in a “C” shape and then transformed into a “K”shape, achieving the same result and effect.

Thus, the action sequence for “holding a stick”is derived as “STICK”.

This represents the standard posture of standing with both hands gripping a single stick. Using the posture of gripping a stick to represent the object stick aligns with the aforementioned thinking model.

These concepts: sTone, chiLd, STICK, are established by demonstrating their corresponding actions: “holding a stone”, “holding a child”, “holding a stick”.

In the early evolution of human beings, it took millions of years to evolve from walking on all fours to standing upright. How to express the action of standing upright?

Break down the posture of human standing, as shown in 201:
s: Depicts the head;
T: Depicts the trunk with both arms located on both sides of the thighs, similar to the shape of merging “Λ” (two arms) and “I” (trunk) together, with “I” covered by “Λ”, (or similar to “/|\”);
Further refine the depiction of the small extremities:
a: Depicts the thumb extending;
d: Depicts the hand with the palm below the wrist and the back of the hand facing forward;
Describe the supporting base of the body, namely the legs:
n: Depicts the shape of the legs.

Among these symbols, “sTn” depicts the head, the trunk with both arms, and the legs respectively. Simply placing “T” below “s”, and “n” below “T”, the human standing posture is depicted;
Thus, we can derive a sequence of poses for standing: “sTand”. And vice versa, the action posture can also be reconstructed from this symbol sequence.

In the present disclosure, the pair of upper case letter and lower case letter of the same shape, such as C c, K k, O o, P p, S s, U u, V v, W w, and so on, depict the same objects.

The various poses of limbs or body parts such as arms, hands, legs, and feet can be mutually switched and changed. The process of change involves the movement and transformation of spatial positions, including: up, down, left, right, inward, outward, etc.

In the present disclosure, the directional vector arrows are simplified and used to indicate the direction and trajectory of the movements of body parts.
r(┌) is used to describe upward movement (simplified form of an upward arrow);
L is used to describe downward movement (simplified form of a downward arrow);
O is used to describe movements towards each other forming a circular shape;
For example, using the morphological symbols including C, r(┌), L and O, can derive these combination sequence: “Cr(┌)” “CL” “CO” “Cro (C┌O)” “CLO” “Cor (CO┌)” “COL”, and the following related action forms can be described, (paying attention to the order of actions over time):
Both arms bend in front of the body to form a semi-circular shape, then move upwards, depicted by using the combination sequence “Cr(┌)”;
Both arms bend in front of the body to form a semi-circular shape, then move downwards, depicted by using the combination sequence “CL”;
Both arms bend in front of the body to form a semi-circular shape, then both hands move towards each other to form a closed circular shape, depicted by using the combination sequence “CO”;
Both arms bend in front of the body to form a semi-circular shape, then move upwards, then both hands move towards each other to form a closed circular shape, depicted by using the combination sequence “Cro (C┌O)”;
Both arms bend in front of the body to form a semi-circular shape, then move downwards, then both hands move towards each other to form a closed circular shape, depicted by using the combination sequence “CLO”;
Both arms bend in front of the body to form a semi-circular shape, then both hands move towards each other to form a closed circular shape, then move upwards, depicted by using the combination sequence “Cor (CO┌)”;
Both arms bend in front of the body to form a semi-circular shape, then both hands move towards each other to form a closed circular shape, then move downwards, depicted by using the combination sequence “COL”;
Advantages and effects:
Methods and devices for language image natural model architecture, are to
build a natural corresponding mapping conversion system mechanism architecture between language text and visual graphics, images, video images;
analyze and summarize the main limbs modeling, terminal small limb modeling, and motion trajectories involved in modeling transformation;
use, express or understand specific meanings and intentions based on the sequence of modeling and motion trajectory.
The present disclosure conforms to the laws of nature and is simple, efficient, flexible, easy to use, highly extensible, widely applicable and highly versatile.

Some example embodiment application systems of the present invention:
Morphological recorder: It captures data by employing visual cameras or wearable key node sensor, recognizes the forms, shapes and movements of body parts, and converts them into textual symbols.
Virtual digital human: According to input text symbols, it converts and generates a sequence of actions comprising forms, shapes, postures, gestures of body parts, and renders into realistic animations by using physics-based animation techniques or machine learning-driven motion synthesis; controls its virtual arms, hands, and body parts to demonstrate or virtually restore the original meaning or function carried by the input text symbols, through a display device.
Humanoid robot: According to the input text symbols, it converts and generates a sequence of actions comprising forms, shapes, postures, gestures of body parts, and translates these actions into motor commands for the robot's actuators, controls its artificial arms, hands, and body parts to restore, demonstrate or archive the original meaning or function carried by the input text symbols.

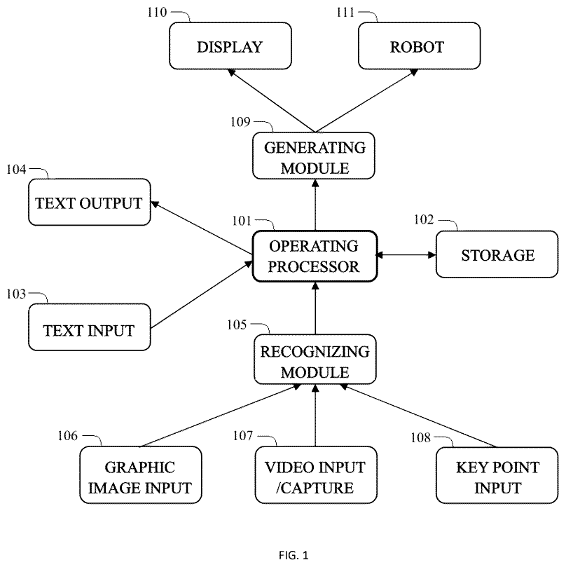

FIG. 1 depicts an example system for language image natural modeling architecture.

The structure of the example system in FIG. 1 includes the following functional components:
The computational processor module 101 performs the mapping algorithm and operates converting function between textual symbols and action forms;
Storage module 102 carries algorithm code, rule library, knowledge base, database, and sample library;
Text input module 103 reads text symbol sequences;
Text output module 104 generates text symbol sequences;
The shape recognizing module 105 obtains visual information, including pictures, images, video animations, real-world image information, or key node position information, identifies body parts, shape postures, posture switching, motion trajectories, and converts them into corresponding symbol sequences; and 105 is a functional module run by 101;
Graphic image input module 106 reads data of static images, pictures;
Video input/capture module 107 reads data of stream image or performs real-time stream image acquisition by visual sensor devices;
Key point input module 108 collects key node location information by wearable sensors;
Modeling posture generating module 109, based on text symbols and action instruction sequences, determine the shape, form, and motion trajectory of component parts; and 109 is a functional module run by 101;
Visual display module 110, based on the posture sequence of the shape, arranges the virtual body parts to be placed in corresponding shapes and postures, switches postures, generates graphics, images, and video animations, and displays them on the display device;
Attitude demonstrating module 111, also known as the execution/actuation module of artificial mechanical devices, controls the mechanical limbs according to the posture sequence, arranges them into corresponding shapes and postures, and switches postures;
In some implementations, the methods and devices described hereby for language image natural modeling architecture, comprise:
at a device comprising one or more peripheral input/output devices, one or more processors, and non-transitory memory:
converting among various types of data performed by one or more processors 101; wherein various types of data comprising: language text symbols, visual graphic images, video stream images, key node position sensing information;
acquiring data through input source devices, the devices comprising:
visual acquisition devices 106 and/or 107, non-transitory storage devices 102, 103, wearable sensing devices 108;
recognizing data at 105, by utilizing computing algorithms, comprising: preprocessing, feature extraction, feature classification; wherein the feature comprises: various forms, shapes, postures, gestures, motion trajectories, orientations of movement;
displaying/demonstrating data through output target devices, the devices comprising: visual display devices 110, mechanical limb devices, robots 111; for virtual digital humans on 110, this involves generating realistic animations synchronized with the detected gestures, using physics-based animation techniques or machine learning-driven motion synthesis; for humanoid robots with 111, the system translates gestures into motor commands, controlling the robot's actuators to mimic the gestures and postures.
for wherein feature classification, establishing a corresponding mapping relationship between language textual symbols and various forms, shapes, postures, gestures, motion trajectories extracted from visual graphic images, video stream images, key node/joint position sensing information; wherein this mapping relationship comprising: symbolizing the shapes and action forms into language textual symbols; and vice versa shaping and action forming the language symbols; and the mutual corresponding mapping conversion comprising:
converting by designing and/or assigning text symbol(s) to depict the components and parts based on basic feature of physical shapes, and vice versa;
converting by designing and/or assigning text symbol(s) to depict the shape and position of the limbs and parts accordingly, and vice versa;
converting by designing and/or assigning text symbol(s) to describe the movement type according to the motion trajectory, orientation of movement of parts, and vice versa;
generating, by comprehensively utilizing the above-mentioned types of converting by depicting or shaping, a string of text symbols 104 or a sequence of action shapes 109, to form an expression with specific meanings, to be used for recording, storing, reproducing, human-machine interactive communication.

In various implementations, the functional modules shown in FIG. 1 can be tailored and configured according to system application requirement. 110 is used for virtual digital human, and 111 is for humanoid robots. 106, 107 and 108 can also be tailored and configured according to system application scenarios.

In some implementations, one or more imaging sensors, such as cameras or depth sensors, are employed to capture the shapes and motions of body parts, including those of the head, shoulders, arms, elbows, fingers, palms, legs, feet, etc. Sophisticated image preprocessing techniques are then applied to enhance visual data quality and prepare it for feature extraction.

Advanced algorithms detect and track key body parts, especially key body joints (e.g., wrists, elbows, shoulders, neck, hips, knees, ankles), extracting parameters like position, orientation, and motion trajectory to build a comprehensive motion profile.

Classify the shapes, forms, postures, and gestures into understandable and expressive appearance, and reach direct and effective manner to fulfill mapping conversion.

In some implementations, designing and/or assigning text symbol(s) to depict the components and parts based on basic shape features comprises:
assigning S to depict the head, especially the side view head shape, or head-spine, or long hair, or being on the head.

In some implementations, designing and/or assigning text symbol(s) to depict the shape and position of the limbs and parts accordingly comprises:
assigning T to depict the shape of trunk and both arms, with both arms located on the sides of the body, extending obliquely downward, and both hands suspended in the outer areas of both thighs; there are some included angles between the arms and the trunk, basically similar to the shape of merging “Λ” (two arms) and “I” (trunk) together, with “I” covered by “Λ”, (or similar to “/|\”);
assigning C to depict the shape of the both arms, with both hands at the same height in front of the abdomen, and the arms are bent and curled into a semicircle (not closed into a circle), forming a C shape;
assigning K to depict the shape of trunk and both arms, with the arms positioned in front of the body, extending forward-upper and forward-lower respectively, maintaining a certain angle between the arms to create the K shape;
assigning h to depict the shape of trunk and a single arm, with the elbow raised upward, which can be flush with or higher than the abdomen;
assigning W to depict a double-arm shape, with the arms positioned on either side of the body, elbows bent, one arm in a V shape, and the both arms combined to form a W shape, with both hands at or above shoulder level;
assigning U to depict a double-arm shape, with the arms raised parallel upward or extended forward-upward to create the U shape;
assigning V to depict a double-arm shape, with the arms raised obliquely upward to present an V shape;
assigning O to depict a double-arm shape, with both arms bent into a closed circular shape;
assigning J to depict a single-arm shape, with the arm raised upward and the hand above the head;
assigning y to depict the shape of trunk and both arms, with both arms raised upward and extended to the sides, showing one hand at the same level or slightly higher than the other;
assigning X to depict a double-arm shape, with the arms in front of the body and the forearms crossed;
assigning Z to depict a double-arm shape, with the arms in front of the body and both forearms parallel up and down, right arm extended to the left, left arm extended to the right;
using asymmetrically combined double-arm shapes; wherein the aforementioned C T W K y and some other shapes are symmetrical double-arm shapes; when necessary, they can be simplified to single-arm shapes; one arm maintains the shape in the above shape, and the other arm is posed in another shape, comprising: Ch, Th, Wh, CT, TW;
assigning CK to depict a double-arm combination shape, with one arm posed in the shape of the C shape, and the other arm posed in the upper arm shape of the K shape;
assigning n to depict the two legs, especially both thighs;
assigning g to depict feet, or knee-shin-foot, or indicate the area under the feet;
assigning ng to depict the combination of parts: legs and feet.

In some implementations, designing and/or assigning text symbol(s) to depict the shape and position of the limbs and parts accordingly comprises:
(the front/forward in the following text refers to the direction in which the body stands upright and looks forward, and the opposite direction to the front is the back/backward);
assigning p to depict the hand shape, with the palm over the wrist and the palm facing forwards;
assigning q to depict the hand shape, with the palm over the wrist and the palm facing backwards;
assigning d to depict the hand shape, with the palm under the wrist and the palm facing backwards;
assigning b to depict the hand shape, with the palm under the wrist and the palm facing forwards;
wherein the aforementioned p q d b, comprising the finger shape being determined based on the function of the action;
assigning F to depict a hand shape, with the palm over wrist and the fingers in a loose grip, fingertips pointing forward, thumb separated from the other fingers, thumb positioned below other fingers;
assigning O to depict a hand shape, with the fingers wrapped into a circular shape;
assigning F to depict a foot;
assigning p to depict a foot;
assigning m to depict the fingers, especially the middle three fingers, with the three fingertips pointing downward;
assigning n to depict two non-thumb fingers with the two fingertips pointing downward;
assigning a to depict the thumb, extended;
assigning i to depict the small finger, extended;
assigning V to depict the tongue, in a bending shape;
assigning W to depict the tongue, in a bending shape;
assigning C to depict the mouth, in a side-view opening shape;
assigning O to depict the mouth, in an opening shape;
assigning O to depict round objects;
assigning D to depict semicircular objects;
assigning I to depict line-shaped objects and things, also comprising straight legs and arms;
assigning V, W to depict fluctuation, turbulence, vibration.

In some implementations, designing and/or assigning text symbol(s) to describe the movement type according to the motion trajectory, orientation of movement of parts, comprises:
assigning r(┌) to describe moving upward;
assigning L to describe moving downward;
assigning O to describe closing inward, or circular motion, or moving backward, or moving leftward (note: it can have multiple meanings depending on the scene, the same below);
assigning e to describe separating outward, or parabola, or moving forward, or moving rightward;
In some implementations, converting process further comprises:
designating symbols or action shapes to indicate additional characteristics, comprising and not limited: strength, size, reality, spatial position, as well as wildcard symbols;
assigning a to indicate an increase in magnitude/intensity, enhancement, reinforcement, affirmation, and confirmation;
assigning i to indicate a decrease in magnitude/intensity, weakening, negation, and illusion;
assigning i or I to refer to an object or thing, refer to the object involved in the action as a wildcard;
assigning n to indicate connecting form, two or more objects are connected together or placed side by side;
assigning p or the corresponding hand shape to indicate the upper position;
assigning b or the corresponding hand shape to indicate the lower or back position;
assigning d or the corresponding hand shape to indicate the lower position;
assigning m or the corresponding hand shape to indicate the middle position;
assigning F or the corresponding hand shape to indicate the front position.

In some implementations, converting process further comprises:
generating a sequence of action symbols and constructing an expression with specific meaning, by comprehensively utilizing various morphological shaping actions, action trajectories, shape posture switching, additional descriptions and other related elements; the process involves acquisition, recognition, generation, and display;
optimizing the sequence of action symbols, based on the frequency of use; and simplifying the high-frequency expression to reduce the length of the sequence, and balancing the factors of ambiguity and efficiency;
optimizing and simplifying as the following, when necessary:
(i) a double-arm-shape can be simplified by using a single-arm-shape to express;
(ii) the large limb shaping actions can be depicted by using the terminal small limbs, or fingers when needed: wherein using finger shapes to express symbols comprising y, w, v, n;
wherein the limbs involved may be various animal body parts or man-made objects with similar physical characteristics;
specifying that the target object of the expression of the meaning of a specific modeling action posture can be the function of the modeling posture itself, or the interactive object involved in the modeling;
inferring the shaping postures before and after, based on static graphic images, to fill in; and forming a complete shaping action sequence;
determining the meaning of symbol or action of multiple choices based on context;
applying semantic and linguistic rules to improve accuracy.

The invention claimed is:

1. A method for language image natural modeling architecture, comprising:
at a device comprising one or more peripheral input/output devices, one or more processors, and non-transitory memory:
converting among various types of data performed by one or more processors; wherein various types of data comprising: language text symbols, visual graphic images, video stream images, key node position sensing information;
acquiring data through input source devices, the devices comprising: visual acquisition devices, non-transitory storage devices, wearable sensing devices;
recognizing data by utilizing computing algorithms, comprising: preprocessing, feature extraction, feature classification; wherein the feature comprises: various forms, shapes, postures, gestures, motion trajectory, orientation of movement;
displaying/demonstrating data through output target devices, the devices comprising: visual display devices, mechanical limb devices, robots;
tailoring and configuring input/output devices according to the application scenarios;
for wherein feature classification, establishing a corresponding mapping relationship between language textual symbols and various forms, shapes, postures, gestures, motion trajectories extracted from visual graphic images, video stream images, key node/joint position sensing information;
wherein this mapping relationship comprising: symbolizing the shapes and action forms into language textual symbols; and vice versa shaping and action forming the language symbols; and the mutual corresponding mapping conversion comprising:
converting by designing and/or assigning text symbol(s) to depict the components and parts based on basic feature of physical shapes, and vice versa;
converting by designing and/or assigning text symbol(s) to depict the shape and position of the limbs and parts accordingly, and vice versa;
converting by designing and/or assigning text symbol(s) to describe the movement type according to the motion trajectory, orientation of movement of parts, and vice versa;
generating, by comprehensively utilizing the above-mentioned types of converting by depicting or shaping, a string of text symbols or a sequence of action shapes, to form an expression with specific meanings, to be used for recording, storing, reproducing, human-machine interactive communication.

2. The method of claim 1, wherein designing and/or assigning text symbol(s) to
depict the components and parts based on basic shape features comprises:
assigning S to depict the head, especially the side view head shape, or head-spine, or long hair, or being on the head.

3. The method of claim 1, wherein designing and/or assigning text symbol(s) to
depict the shape and position of the limbs and parts accordingly comprises:
assigning T to depict the shape of trunk and both arms, with both arms located on the sides of the body, extending obliquely downward, and both hands suspended in the outer areas of both thighs; there are some included angles between the arms and the trunk, basically similar to the shape of merging “Λ” (two arms) and “I” (trunk) together, with “I” covered by “Λ”, (or similar to “/|\”);
assigning C to depict the shape of the both arms, with both hands at the same height in front of the abdomen, and the arms are bent and curled into a semicircle (not closed into a circle), forming a C shape;
assigning K to depict the shape of trunk and both arms, with the arms positioned in front of the body, extending forward-upper and forward-lower respectively, maintaining a certain angle between the arms to create the K shape;
assigning h to depict the shape of trunk and a single arm, with the elbow raised upward, which can be flush with or higher than the abdomen;
assigning W to depict a double-arm shape, with the arms positioned on either side of the body, elbows bent, one arm in a V shape, and the both arms combined to form a W shape, with both hands at or above shoulder level;
assigning U to depict a double-arm shape, with the arms raised parallel upward or extended forward-upward to create the U shape;
assigning V to depict a double-arm shape, with the arms raised obliquely upward to present an V shape;
assigning O to depict a double-arm shape, with both arms bent into a closed circular shape;
assigning J to depict a single-arm shape, with the arm raised upward and the hand above the head;
assigning y to depict the shape of trunk and both arms, with both arms raised upward and extended to the sides, showing one hand at the same level or slightly higher than the other;
assigning X to depict a double-arm shape, with the arms in front of the body and the forearms crossed;
assigning Z to depict a double-arm shape, with the arms in front of the body and both forearms parallel up and down, right arm extended to the left, left arm extended to the right;
using asymmetrically combined double-arm shapes: wherein the aforementioned C T W K y and some other shapes are symmetrical double-arm shapes; when necessary, they can be simplified to single-arm shapes;
one arm maintains the shape in the above shape, and the other arm is posed in another shape, comprising: Ch, Th, Wh, CT, TW;
assigning CK to depict a double-arm combination shape, with one arm posed in the shape of the C shape, and the other arm posed in the upper arm shape of the K shape;
assigning n to depict the two legs, especially both thighs;
assigning g to depict feet, or knee-shin-foot, or indicate the area under the feet;
assigning ng to depict the combination of parts: legs and feet.

4. The method of claim 1, wherein designing and/or assigning text symbol(s) to
depict the shape and position of the limbs and parts accordingly comprises:
(the front/forward in the following text refers to the direction in which the body stands upright and looks forward, and the opposite direction to the front is the back/backward);
assigning p to depict the hand shape, with the palm over the wrist and the palm facing forwards;
assigning q to depict the hand shape, with the palm over the wrist and the palm facing backwards;
assigning d to depict the hand shape, with the palm under the wrist and the palm facing backwards;
assigning b to depict the hand shape, with the palm under the wrist and the palm facing forwards;
wherein the aforementioned p q d b, comprising the finger shape being determined based on the function of the action;
assigning F to depict a hand shape, with the palm over wrist and the fingers in a loose grip, fingertips pointing forward, thumb separated from the other fingers, thumb positioned below other fingers;
assigning O to depict a hand shape, with the fingers wrapped into a circular shape;
assigning F to depict a foot;
assigning p to depict a foot;
assigning m to depict the fingers, especially the middle three fingers, with the three fingertips pointing downward;
assigning n to depict two non-thumb fingers with the two fingertips pointing downward;
assigning a to depict the thumb, extended;
assigning i to depict the small finger, extended;
assigning V to depict the tongue, in a bending shape;
assigning W to depict the tongue, in a bending shape;
assigning C to depict the mouth, in a side-view opening shape;
assigning O to depict the mouth, in an opening shape;
assigning O to depict round objects;
assigning D to depict semicircular objects;
assigning I to depict line-shaped objects and things, also comprising straight legs and arms;
assigning V, W to depict fluctuation, turbulence, vibration.

5. The method of claim 1, wherein designing and/or assigning text symbol(s) to
describe the movement type according to the motion trajectory, orientation of movement of parts, comprises:
assigning r(┌) to describe moving upward;
assigning L to describe moving downward;
assigning O to describe closing inward, or circular motion, or moving backward, or moving leftward (note: it can have multiple meanings depending on the scene, the same below);
assigning e to describe separating outward, or parabola, or moving forward, or moving rightward.

6. The method of claim 1, further comprising:
designating symbols or action shapes to indicate additional characteristics, comprising and not limited to: strength, size, reality, spatial position, as well as wildcard symbols;
assigning a to indicate an increase in magnitude/intensity, enhancement, reinforcement, affirmation, and confirmation;
assigning i to indicate a decrease in magnitude/intensity, weakening, negation, and illusion;
assigning i or I to refer to an object or thing, refer to the object involved in the action as a wildcard;
assigning n to indicate connecting form, two or more objects are connected together or placed side by side;
assigning p or the corresponding hand shape to indicate the upper position;
assigning b or the corresponding hand shape to indicate the lower or back position;
assigning d or the corresponding hand shape to indicate the lower position;
assigning m or the corresponding hand shape to indicate the middle position;
assigning F or the corresponding hand shape to indicate the front position.

7. The method of claim 1, further comprising:
generating a sequence of action symbols and constructing an expression with specific meaning, by comprehensively utilizing various morphological shaping actions, action trajectories, shape posture switching, additional descriptions and other related elements; the process involves acquisition, recognition, generation, and display;
optimizing the sequence of action symbols, based on the frequency of use; and simplifying the high-frequency expression to reduce the length of the sequence, and balancing the factors of ambiguity and efficiency;
optimizing and simplifying as the following, when necessary:
(i) a double-arm-shape can be simplified by using a single-arm-shape to express;
(ii) the large limb shaping actions can be depicted by using the terminal small limbs, or fingers when needed: wherein using finger shapes to express symbols comprising w, v, n, y;
wherein the limbs involved may be various animal body parts or man-made objects with similar physical characteristics;
specifying that the target object of the expression of the meaning of a specific modeling action posture can be the function of the modeling posture itself, or the interactive object involved in the modeling;
inferring the shaping postures before and after, based on static graphic images, to fill in; and forming a complete shaping action sequence;
determining the meaning of symbol or action of multiple choices based on context;
applying semantic and linguistic rules to improve accuracy.

8. A device for language image natural modeling architecture, comprising at least one processor; and a non-transitory memory communicatively coupled to the at least one processor, the non-transitory memory storing instructions which, when executed by the at least one processor, cause the at least one processor to perform operations comprising:
converting among various types of data performed by one or more processors; wherein various types of data comprising: language text symbols, visual graphic images, video stream images, key node position sensing information;
acquiring data through input source devices, the devices comprising: visual acquisition devices, non-transitory storage devices, wearable sensing devices;
recognizing data by utilizing computing algorithms, comprising: preprocessing, feature extraction, feature classification; wherein the feature comprises: various forms, shapes, postures, gestures, motion trajectories, orientations of movement;
displaying/demonstrating data through output target devices, the devices comprising: visual display devices, mechanical limb devices, robots;
tailoring and configuring input/output devices according to the application scenarios;
for wherein feature classification, establishing a corresponding mapping relationship between language textual symbols and various forms, shapes, postures, gestures, motion trajectories extracted from visual graphic images, video stream images, key node/joint position sensing information; wherein this mapping relationship comprising: symbolizing the shapes and action forms into language textual symbols; and vice versa shaping and action forming the language symbols; and the mutual corresponding mapping conversion comprising:
converting by designing and/or assigning text symbol(s) to depict the components and parts based on basic feature of physical shapes, and vice versa;
converting by designing and/or assigning text symbol(s) to depict the shape and position of the limbs and parts accordingly, and vice versa;
converting by designing and/or assigning text symbol(s) to describe the movement type according to the motion trajectory, orientation of movement of parts, and vice versa;
generating, by comprehensively utilizing the above-mentioned types of converting by depicting or shaping, a string of text symbols or a sequence of action shapes, to form an expression with specific meanings, to be used for recording, storing, reproducing, human-machine interactive communication; learning and training, by reading various preset data from the data acquisition device, extracting, classifying, to determine, optimize processing parameters and processes.

9. The device of claim 8, wherein designing and/or assigning text symbol(s) to
depict the components and parts based on basic shape features comprises:
assigning S to depict the head, especially the side view head shape, or head-spine, or long hair, or being on the head.

10. The device of claim 8, wherein designing and/or assigning text symbol(s) to depict the shape and position of the limbs and parts accordingly comprises:
assigning T to depict the shape of trunk and both arms, with both arms located on the sides of the body, extending obliquely downward, and both hands suspended in the outer areas of both thighs; there are some included angles between the arms and the trunk, basically similar to the shape of merging “Λ” (two arms) and “I” (trunk) together, with “I” covered by “Λ”, (or similar to “/|\”);
assigning C to depict the shape of the both arms, with both hands at the same height in front of the abdomen, and the arms are bent and curled into a semicircle (not closed into a circle), forming a C shape;
assigning K to depict the shape of trunk and both arms, with the arms positioned in front of the body, extending forward-upper and forward-lower respectively, maintaining a certain angle between the arms to create the K shape;
assigning h to depict the shape of trunk and a single arm, with the elbow raised upward, which can be flush with or higher than the abdomen;
assigning W to depict a double-arm shape, with the arms positioned on either side of the body, elbows bent, one arm in a V shape, and the both arms combined to form a W shape, with both hands at or above shoulder level;
assigning U to depict a double-arm shape, with the arms raised parallel upward or extended forward-upward to create the U shape;
assigning V to depict a double-arm shape, with the arms raised obliquely upward to present an V shape;
assigning O to depict a double-arm shape, with both arms bent into a closed circular shape;
assigning J to depict a single-arm shape, with the arm raised upward and the hand above the head;
assigning y to depict the shape of trunk and both arms, with both arms raised upward and extended to the sides, showing one hand at the same level or slightly higher than the other;
assigning X to depict a double-arm shape, with the arms in front of the body and the forearms crossed;
assigning Z to depict a double-arm shape, with the arms in front of the body and both forearms parallel up and down, right arm extended to the left, left arm extended to the right;
using asymmetrically combined double-arm shapes: wherein the aforementioned C T W K y and some other shapes are symmetrical double-arm shapes; when necessary, they can be simplified to single-arm shapes;
one arm maintains the shape in the above shape, and the other arm is posed in another shape, comprising: Ch, Th, Wh, CT, TW;
assigning CK to depict a double-arm combination shape, with one arm posed in the shape of the C shape, and the other arm posed in the upper arm shape of the K shape;
assigning n to depict the two legs, especially both thighs;
assigning g to depict feet, or knee-shin-foot, or indicate the area under the feet;
assigning ng to depict the combination of parts: legs and feet.

11. The device of claim 8, wherein designing and/or assigning text symbol(s) to depict the shape and position of the limbs and parts accordingly comprises:
(the front/forward in the following text refers to the direction in which the body stands upright and looks forward, and the opposite direction to the front is the back/backward);
assigning p to depict the hand shape, with the palm over the wrist and the palm facing forwards;
assigning q to depict the hand shape, with the palm over the wrist and the palm facing backwards;
assigning d to depict the hand shape, with the palm under the wrist and the palm facing backwards;
assigning b to depict the hand shape, with the palm under the wrist and the palm facing forwards;
wherein the aforementioned p q d b, comprising the finger shape being determined based on the function of the action;
assigning F to depict a hand shape, with the palm over wrist and the fingers in a loose grip, fingertips pointing forward, thumb separated from the other fingers, thumb positioned below other fingers;
assigning O to depict a hand shape, with the fingers wrapped into a circular shape;
assigning F to depict a foot;
assigning p to depict a foot;
assigning m to depict the fingers, especially the middle three fingers, with the three fingertips pointing downward;
assigning n to depict two non-thumb fingers with the two fingertips pointing downward;
assigning a to depict the thumb, extended;
assigning i to depict the small finger, extended;
assigning V to depict the tongue, in a bending shape;
assigning W to depict the tongue, in a bending shape;
assigning C to depict the mouth, in a side-view opening shape;
assigning O to depict the mouth, in an opening shape;
assigning O to depict round objects;
assigning D to depict semicircular objects;
assigning I to depict line-shaped objects and things, also comprising straight legs and arms;
assigning V, W to depict fluctuation, turbulence, vibration.

12. The device of claim 8, wherein designing and/or assigning text symbol(s) to
describe the movement type according to the motion trajectory, orientation of movement of parts, comprises:
assigning r(┌) to describe moving upward;
assigning L to describe moving downward;
assigning O to describe closing inward, or circular motion, or moving backward, or moving leftward (note: it can have multiple meanings depending on the scene, the same below);
assigning e to describe separating outward, or parabola, or moving forward, or moving rightward.

13. The device of claim 8, further comprising:
designating symbols or action shapes to indicate additional characteristics, comprising and not limited to: strength, size, reality, spatial position, as well as wildcard symbols;
assigning a to indicate an increase in magnitude/intensity, enhancement, reinforcement, affirmation, and confirmation;
assigning i to indicate a decrease in magnitude/intensity, weakening, negation, and illusion;
assigning i or I to refer to an object or thing, refer to the object involved in the action as a wildcard;
assigning n to indicate connecting form, two or more objects are connected together or placed side by side;
assigning p or the corresponding hand shape to indicate the upper position;
assigning b or the corresponding hand shape to indicate the lower or back position;
assigning d or the corresponding hand shape to indicate the lower position;
assigning m or the corresponding hand shape to indicate the middle position;
assigning F or the corresponding hand shape to indicate the front position.

14. The device of claim 8, further comprising:
generating a sequence of action symbols and constructing an expression with specific meaning, by comprehensively utilizing various morphological shaping actions, action trajectories, shape posture switching, additional descriptions and other related elements; the process involves acquisition, recognition, generation, and display;
optimizing the sequence of action symbols, based on the frequency of use;
and simplifying the high-frequency expression to reduce the length of the sequence, and balancing the factors of ambiguity and efficiency;
optimizing and simplifying as the following, when necessary:
(i) a double-arm-shape can be simplified by using a single-arm-shape to express;
(ii) the large limb shaping actions can be depicted by using the terminal small limbs, or fingers when needed: wherein using finger shapes to express symbols comprising w, v, n, y;
wherein the limbs involved may be various animal body parts or man-made objects with similar physical characteristics;
specifying that the target object of the expression of the meaning of a specific modeling action posture can be the function of the modeling posture itself, or the interactive object involved in the modeling;
inferring the shaping postures before and after, based on static graphic images, to fill in; and forming a complete shaping action sequence;
determining the meaning of symbol or action of multiple choices based on context;
applying semantic and linguistic rules to improve accuracy.

15. A non-transitory computer-readable storage medium having stored thereon instructions that, when executed by one or more processors, cause the one or more processors to perform a method for language image natural modeling architecture, comprising:
converting among various types of data performed by one or more processors; wherein various types of data comprising: language text symbols, visual graphic images, video stream images, key node position sensing information;
acquiring data through input source devices, the devices comprising: visual acquisition devices, non-transitory storage devices, wearable sensing devices;
recognizing data by utilizing computing algorithms, comprising: preprocessing, feature extraction, feature classification; wherein the feature comprises: various forms, shapes, postures, gestures, motion trajectories, orientations of movement;
displaying/demonstrating data through output target devices, the devices comprising: visual display devices, mechanical limb devices, robots;
tailoring and configuring input/output devices according to the application scenarios;
for wherein feature classification, establishing a corresponding mapping relationship between language textual symbols and various forms, shapes, postures, gestures, motion trajectories extracted from visual graphic images, video stream images, key node/joint position sensing information; wherein this mapping relationship comprising: symbolizing the shapes and action forms into language textual symbols; and vice versa shaping and action forming the language symbols; and the mutual corresponding mapping conversion comprising:
converting by designing and/or assigning text symbol(s) to depict the components and parts based on basic feature of physical shapes, and vice versa;
converting by designing and/or assigning text symbol(s) to depict the shape and position of the limbs and parts accordingly, and vice versa;
converting by designing and/or assigning text symbol(s) to describe the movement type according to the motion trajectory, orientation of movement of parts, and vice versa;
generating, by comprehensively utilizing the above-mentioned types of converting by depicting or shaping, a string of text symbols or a sequence of action shapes, to form an expression with specific meanings, to be used for recording, storing, reproducing, human-machine interactive communication.

16. The non-transitory computer-readable storage medium of claim 15, wherein
designing and/or assigning text symbol(s) to depict the components and parts based on basic shape features comprises:
assigning S to depict the head, especially the side view head shape, or head-spine, or long hair, or being on the head.

17. The non-transitory computer-readable storage medium of claim 15, wherein
designing and/or assigning text symbol(s) to depict the shape and position of the limbs and parts accordingly comprises:
assigning T to depict the shape of trunk and both arms, with both arms located on the sides of the body, extending obliquely downward, and both hands suspended in the outer areas of both thighs; there are some included angles between the arms and the trunk, basically similar to the shape of merging “Λ” (two arms) and “I” (trunk) together, with “I” covered by “Λ”, (or similar to “/|\”);
assigning C to depict the shape of the both arms, with both hands at the same height in front of the abdomen, and the arms are bent and curled into a semicircle (not closed into a circle), forming a C shape;
assigning K to depict the shape of trunk and both arms, with the arms positioned in front of the body, extending forward-upper and forward-lower respectively, maintaining a certain angle between the arms to create the K shape;
assigning h to depict the shape of trunk and a single arm, with the elbow raised upward, which can be flush with or higher than the abdomen;
assigning W to depict a double-arm shape, with the arms positioned on either side of the body, elbows bent, one arm in a V shape, and the both arms combined to form a W shape, with both hands at or above shoulder level;
assigning U to depict a double-arm shape, with the arms raised parallel upward or extended forward-upward to create the U shape;
assigning V to depict a double-arm shape, with the arms raised obliquely upward to present an V shape;
assigning O to depict a double-arm shape, with both arms bent into a closed circular shape;
assigning J to depict a single-arm shape, with the arm raised upward and the hand above the head;
assigning y to depict the shape of trunk and both arms, with both arms raised upward and extended to the sides, showing one hand at the same level or slightly higher than the other;
assigning X to depict a double-arm shape, with the arms in front of the body and the forearms crossed;
assigning Z to depict a double-arm shape, with the arms in front of the body and both forearms parallel up and down, right arm extended to the left, left arm extended to the right;
using asymmetrically combined double-arm shapes: wherein the aforementioned C T W K y and some other shapes are symmetrical double-arm shapes; when necessary, they can be simplified to single-arm shapes;
one arm maintains the shape in the above shape, and the other arm is posed in another shape, comprising: Ch, Th, Wh, CT, TW;
assigning CK to depict a double-arm combination shape, with one arm posed in the shape of the C shape, and the other arm posed in the upper arm shape of the K shape;
assigning n to depict the two legs, especially both thighs;
assigning g to depict feet, or knee-shin-foot, or indicate the area under the feet;
assigning ng to depict the combination of parts: legs and feet.

18. The non-transitory computer-readable storage medium of claim 15, wherein designing and/or assigning text symbol(s) to depict the shape and position of the limbs and parts accordingly comprises:
(the front/forward in the following text refers to the direction in which the body stands upright and looks forward, and the opposite direction to the front is the back/backward);
assigning p to depict the hand shape, with the palm over the wrist and the palm facing forwards;
assigning q to depict the hand shape, with the palm over the wrist and the palm facing backwards;
assigning d to depict the hand shape, with the palm under the wrist and the palm facing backwards;
assigning b to depict the hand shape, with the palm under the wrist and the palm facing forwards;
wherein the aforementioned p q d b, comprising the finger shape being determined based on the function of the action;
assigning F to depict a hand shape, with the palm over wrist and the fingers in a loose grip, fingertips pointing forward, thumb separated from the other fingers, thumb positioned below other fingers;
assigning O to depict a hand shape, with the fingers wrapped into a circular shape;
assigning F to depict a foot;
assigning p to depict a foot;
assigning m to depict the fingers, especially the middle three fingers, with the three fingertips pointing downward;
assigning n to depict two non-thumb fingers with the two fingertips pointing downward;
assigning a to depict the thumb, extended;
assigning i to depict the small finger, extended;
assigning V to depict the tongue, in a bending shape;
assigning W to depict the tongue, in a bending shape;
assigning C to depict the mouth, in a side-view opening shape;
assigning O to depict the mouth, in an opening shape;
assigning O to depict round objects;
assigning D to depict semicircular objects;
assigning I to depict line-shaped objects and things, also comprising straight legs and arms;
assigning V, W to depict fluctuation, turbulence, vibration.

19. The non-transitory computer-readable storage medium of claim 15, wherein
designing and/or assigning text symbol(s) to describe the movement type according to the motion trajectory, orientation of movement of parts, comprises:
assigning r(┌) to describe moving upward;
assigning L to describe moving downward;
assigning O to describe closing inward, or circular motion, or moving backward, or moving leftward (note: it can have multiple meanings depending on the scene, the same below);
assigning e to describe separating outward, or parabola, or moving forward, or moving rightward.
